(19) United States
(12) Patent Application Publication
(10) Pub. No.: US 2006/0251856 A1
(43) Pub. Date: Nov. 9, 2006

(54) Thermal interface composit structure and method of making same

(75) Inventors: Christopher H. McCoy, Natick, MA (US); John T. Chen, Somerville, MA (US); David R. Beaulieu, Groton, MA (US)

Correspondence Address: WILMER CUTLER PICKERING HALE AND DORR LLP, 60 STATE STREET, BOSTON, MA, 02109, US

(73) Assignee: Surface Logix, Inc., Brighton, MA (US)

(21) Appl. No.: 11/481,547

(22) Filed: Jul. 6, 2006

Related U.S. Application Data
(63) Continuation of application No. 10/713,619, filed on Nov. 13, 2003.
(60) Provisional application No. 60/425,785, filed on Nov. 13, 2002.
(60) Provisional application No. 60/425,786, filed on Nov. 13, 2002.

(51) Int. Cl. B32B 3/10

(52) U.S. Cl. 428/131

(57) ABSTRACT

A thermal management material that may be used is thermal interface material is described. An apparatus and methods of the making the thermal management material are also described, which includes a roll-to-roll apparatus for making the thermal management material.

### RELATED APPLICATIONS

This application is a continuation of U.S. application Ser. No. 10/713,619 filed Nov. 13, 2003, which claims the benefit of priority under 35 U.S.C. § 119(e) from U.S. Provisional Application Ser. No. 60/425,786 filed Nov. 13, 2002, entitled “An Apparatus for Roll-to-Roll Fabrication of Molded Articles,” and U.S. Provisional Application Ser. No. 60/425,785 filed Nov. 13, 2002, entitled “Thermal Interface Composite Structure,” the entire contents of which are incorporated herein by reference.

### FIELD OF THE INVENTION

The present invention relates to thermal management material, and methods and an apparatus for making same.

### BACKGROUND OF THE INVENTION

Electronic devices that generate heat during use typically have components that generate heat that must be dissipated for continued proper device operation. There are a number of available methods for management of this generated heat through a combination of radiation, convection and conduction.

In the electrical/electronic area, heat sinks and cooling devices, such as fans, have served the heat management function. For example, power semiconductor devices and integrated circuits are typically mounted on a finned heat sink to dissipate heat generated during operation. In order for heat sinks to function properly, there must be sufficient contact with the device (or surface to be cooled) and the heat sink to which the heat is to be transferred. To obtain a good thermal junction between the device to be cooled and the heat sink, a thermal interface material is employed. This material can take the form of (i) a grease loaded with a good thermal conductor, such as alumina, (ii) a sheet of silicone rubber loaded with a thermal conductor, or (iii) some other material that forms an intimate thermal contact between the device to be cooled and the surface of the heat sink. While thermal interface materials, such as alumina-loaded silicone rubber, are easy to use, their thermal resistance is rather high and large mounting pressures are needed to achieve a good thermal junction. Thermal pastes offer better performance but are more difficult to employ in an automated assembly process.

The surface to be cooled is not always planar. Accordingly, the thermal interface material needs to be able to conform to such non-planar surfaces. There is also a desire to be able to easily and effectively produce such a flexible form of thermal interface material that may be easily patterned for the surface to be cooled.

### SUMMARY OF THE INVENTION

The present invention relates to a thermal management material that may be used as a thermal interface material. Moreover, the present invention also relates to methods and an apparatus of the making the thermal management material. The apparatus for making the thermal management material includes a roll-to-roll apparatus.

The thermal management material of the present invention may be in the form of a thin membrane. The thermal membrane may be a composite material containing a thermal conductivity-enhancing component. For example, the membrane may be formed from poly (dimethoxysilane) or similar materials that are loaded with alumina, or zinc oxide, or equivalent material. The composite material may be prepared by blending alumina powder into poly (dimethylsiloxane) prior to cross-linking/curing the material. Alternatively, the thermal conductor, e.g., alumina powder, can be omitted and still be within the scope of the present invention.

The thermal membrane is preferably patterned with holes that are filled with a highly thermally conducting paste or material. The thermal membrane with the filled holes is capable of maintaining physical separation and electrical insulation between, for example, a power semiconductor device package and a heat sink yet also capable of transferring heat at a highly improved rate.

Thermal membrane just described, preferably is a soft, compliant thermal interface that requires minimal mounting pressure and delivers much higher thermal conductivity (heat transfer) than conventional thermal interface layers. This thermal membrane will function as a physical and electrical separation layer between the device package and the heat sink, while the filled regions greatly increase the overall thermal conductivity of the composite structure.

Generally, the thermal membrane may be formed according to the following method.

Using soft lithography, a master is fabricated in photoresist on a wafer. A two-part silicone rubber system or its equivalent is mixed and then alumina powder or an equivalent is added to a predetermined level. Preferably, alumina powder is added to the maximum quantity possible while still maintaining a spin-coated slurry consistency. The material is spun onto the master. The desire is to form membrane as thin as possible, but not so thin to be prone to tearing.

Once the membrane is formed, it is thermally cured and is removed from the master. The holes in the membrane preferably are filled with a highly thermally conductive but electrically insulative material. The membrane may have any desired pattern of holes that are filled with highly thermally conductive electronically insulative material and still be within the scope of the present invention. The electrical insulation property may or may not be required depending on the specific application.

### BRIEF DESCRIPTION OF THE DRAWINGS

FIG. 1A showed a thermal membrane 101 according to the present invention with an array of holes (102) filled with highly thermally conductive electronically insulated material (103).

FIG. 1B show the thermal membrane (101) shown in FIG. 1A forming an intimate thermal junction between to be cooled device (104) and a heat sink (105).

FIG. 2A shows a relationship of hole radii and hole separation for the thermal membrane (101).

FIG. 2B shows a plot of a relationship between hole diameter and thermal conductivity.

FIG. 3 shows a method of determining value that is provided by use of the present invention based on thermal resistance as it relates to cost and performance for a series of heat sinks for a fixed design, where the slope of line (352) indicates that each 0.0344 degree/watt improvement in thermal performance costs a dollar.

FIG. 4 shows a roll-to-roll apparatus (410) of the present invention for producing thermal membrane (101).

### DETAILED DESCRIPTION

The present invention is directed to a thermal management membrane (or thermal membrane). The present invention also is directed to methods and an apparatus for making the thermal membrane.

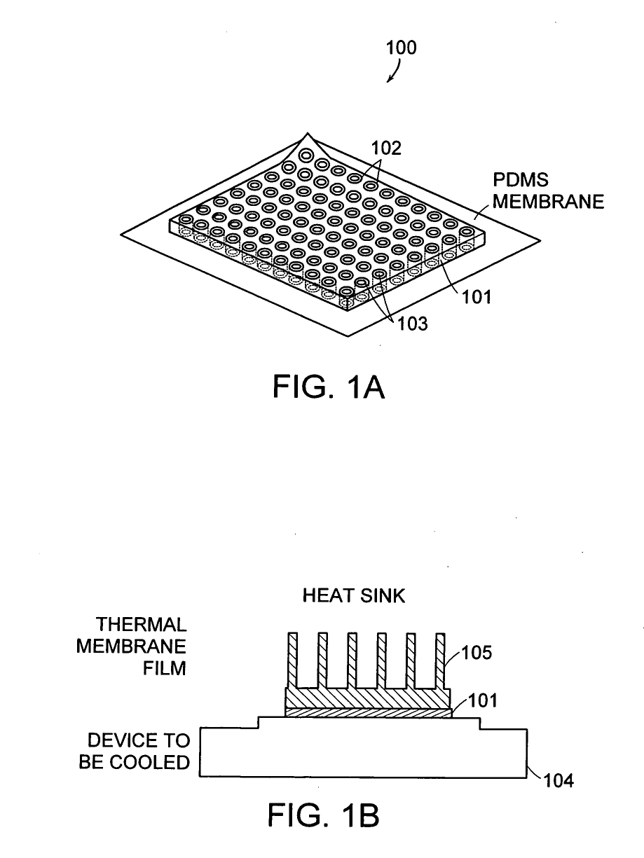

Referring to FIG. 1A generally at 100, the thermal membrane 101 is a composite material containing a thermal conductivity-enhancing component. This composite, for example, may be poly (dimethoxysilane) (PDMS) or similar materials loaded with alumina, or zinc oxide, aluminum nitride or other highly conductive material. Such a material may be prepared by blending alumina powder in a conventional memory into poly (dimethylsiloxane) (PDMS) prior to cross-linking/curing. The blending may occur by adding the highly conductive material to a vat containing PDMS and stirring, thereby loading PDMS with the highly conductive material. Alternatively, the thermal conductor, e.g., alumina powder, can be omitted and still be within the scope of the present invention.

As shown in FIG. 1A, the thermal membrane 101 has a pattern of holes 102. These holes are preferably filled with a highly thermally conducting paste or material 103. Thermal membrane 101 is capable of maintaining physical separation and electrical insulation between, for example, a power semiconductor device package 104 and a heat sink 105.

Thermal membrane developed according to the present invention is a soft, compliant thermal interface that requires minimal mounting pressure and delivers much higher thermal conductivity than conventional thermal interface layers. Thermal membrane 101 provides physical and electrical separation between the device package 104 and the heat sink 105, while the filled regions greatly increase the overall thermal conductivity of the composite structure.

Generally, a structure such as thermal membrane 101 may be formed from a base membrane that has through-holes molded in it. The through-holes are then filled with a highly thermally conductive material. The base membrane may be molded using soft lithography methods in which a master is fabricated in photoresist on a silicon wafer. The master is then used as a mold for making a membrane.

The base membrane may be formed from a two-part silicone rubber system or its equivalent that is mixed, then alumina powder or an equivalent is added to a predetermined level. Preferably, alumina powder is added to the maximum quantity possible while still maintaining a spin-coated slurry consistency. The material is spun onto the master with a target thickness of 30-100 μm. The membrane is preferably formed as thin as possible, but not too thin as would tend to tear.

Soft lithographic methods of forming the membrane are described in the following publications which are incorporated by reference: Folch, A, et al., Molding of Deep Polydimethylsiloxane Microstructures for Microfluidics and Biological Applications, J. Biomech. Eng. 1999; 121:28 (Appendix A); Xia, Y.N., Soft Lithography, Angew Chem-Int. Edit. Engl. 1998; 37:551 (Appendix B); Jackman, R.I., et al., Using Elastomeric Membranes as Dry Resists and for Dry Lift-Off, Langmuir 1999; 7:1013 (Appendix C); Jackman, R.J. et al., Fabricating Large Arrays of Microwells with Arbitrary Dimensions and Filling Them Using Discontinuous Dewetting, Analyt. Chem. 1998; 70:2280 (Appendix D); Duffy, D.C. et al., Patterning Electroluminescent Materials with Feature Sizes as Small as 5 μm Using Elastomeric Membranes as Masks for Dry Lift Off, Adv. Mater. 11(7) 1999, 546:52 (Appendix E).

The material is thermally cured and the membrane is removed from the master. The holes in the membrane are then filled with a highly thermally conductive but electrically insulative material. It is understood that any desired pattern of holes may be used and still be within the scope of the present invention. The electrical insulation property of the membrane may or may not be required depending on the specific application.

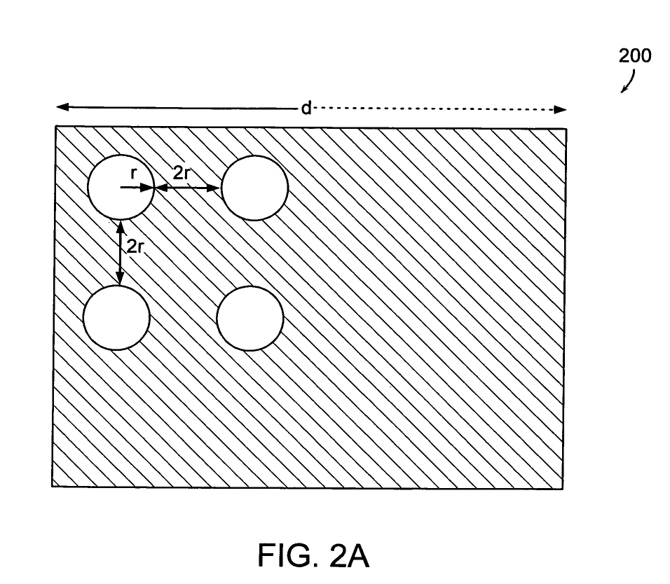

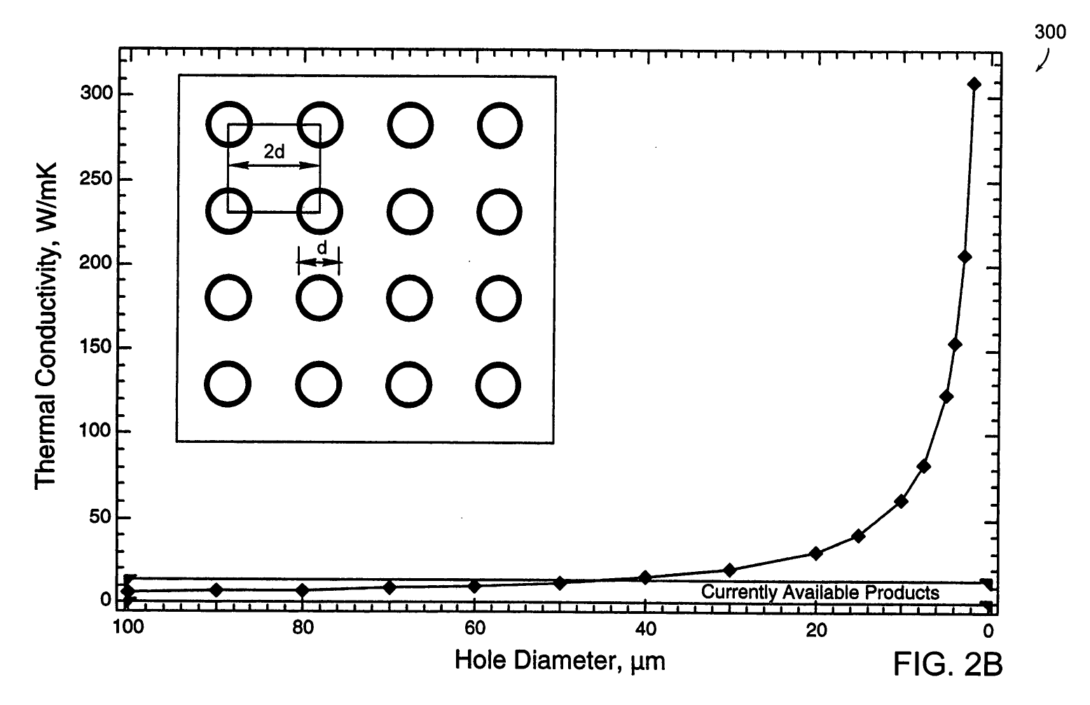

Referring to FIG. 2A, generally at 200, a representative relationship of hole radii to hole separation is shown. For example, for an array of equally spaced holes of radius r, spaced 2r apart, the total hole area for a square area of length d on a side for d>>r (for a total surface area of d²) is given by π*r² number of holes=π*r²(d²/4r). The hole area fraction is given by π*r²d²/16r²=π/16=19.6%. For holes spaced distance r apart, the hole area fraction is π/9 or 34.9%. This calculation of hole fraction, therefore, is 19.6% if the holes are spaced at four times their radius, center-to-center, or 34.9% if they are spaced at three times their radius, center to center. It is therefore understood that the closer the hole spacing the greater the ability of the membrane to transfer heat.

FIG. 2B generally at 300, shows the relationship of hole diameter and thermal conductivity. As shown, the hole diameter increases past 40 μm, the thermal conductivity begins increasing exponentially. The present invention provides for the type of thermal conductivity increase.

As an example, the composite thermal structure according to the present invention, preferably includes a membrane loaded with alumina having a conductivity of 0.5 W/mK, and a hole-filling material having a conductivity of 50 W/mK. Such a membrane will have an expected overall conductivity according to the following expression: 0.349(50)+0.651(0.5)=17.8 W/mK. Given this, the thermal membrane of the present invention will now be described in a practical application to provide an example of its heat transfer capabilities compared to conventional material.

An Intel Pentium IV® has a heat dissipation area equaling approximately 30×30 mm (9 square cm) and requires heat dissipation of 55.3 W @ 1.4 GHz to 75.3 W @ 2 GHz core frequency. A conventional thermal interface grease has a thermal conductivity in the range of 0.75 W/mK. The thermal resistance of a 50 μm thick film of grease interface over a 9 square cm area is 50 E−6 m/(9E−4 m²*0.75 W/mK)=0.074° C./W. This gives a temperature rise across the thermal interface junction of 4.1 degrees at 55.3 Watts and 5.4 degrees at 75.3 Watts.

According to the present invention, the thermal membrane with a 50 μm thickness would have a thermal resistance of 50 E−6 m/(9E−4 m²*17.8 W/mK)=0.0031° C./W. This yields a temperature rise across the thermal interface junction of 0.17 degrees at 55.3 Watts and 0.23 degrees at 75.3 Watts for the case of the Pentium IV®. Thus, an overall thermal resistance decrease is according to the following: 0.074−0.0031=0.071° C./W.

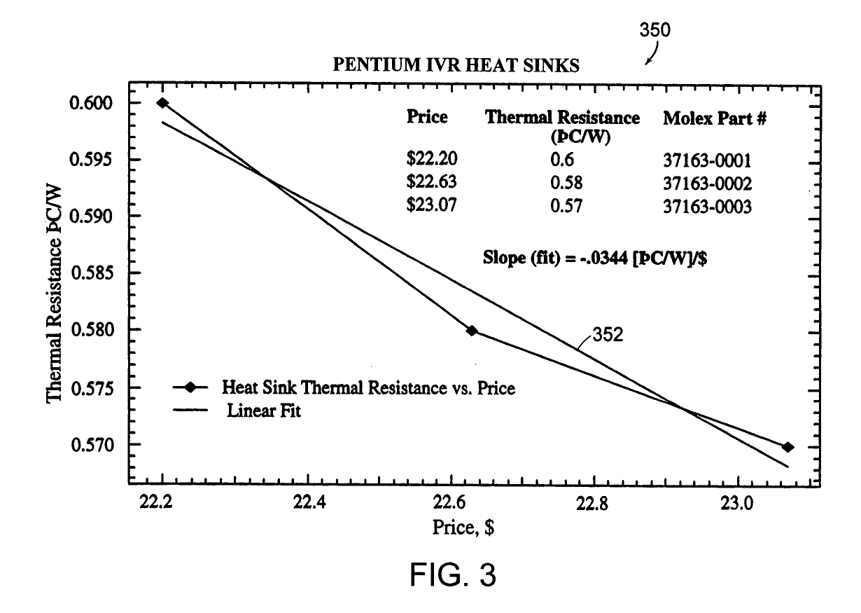

The present invention also provides benefits that may be measured economically based on its efficiency in heat transfer along with its thermal isolation. The economic value of this reduction can be determined from heat sink prices as a function of thermal resistance. The typical price and thermal resistance for three Molex heat sinks for the Pentium IV® are plotted in FIG. 3. From this Figure, a value of 0.071° C./W /[0.0344(° C./W)/$]=$2.06 is subtracted for the increased thermal performance of the present invention. More directly, this is seen by understanding that the least expensive heat sink at $22.20 combined with the invention provides superior thermal performance compared to the most expensive heat sink at $23.07 using a conventional thermal interface material.

While much attention is now paid to heat dissipation in microprocessors, they actually constitute a relatively mild class of thermal management problems, producing only about 8 Watts per square centimeter of dissipating area. A far more stringent class of thermal management is that of discrete power semiconductors. The thermal dissipation area of a TO-220 package (a common, broadly used power package for discrete semiconductors and integrated circuits) is in the range of 0.95-1.05 square centimeters, i.e., the area of the metal heat spreader. Rated power dissipations run to 200 Watts. A device dissipating 100 Watts yields a dissipation power density of 100 Watts per square centimeter. The thermal resistance of a 50 μm thick film of conventional grease is 50 E−6 m/(1 E−4 m²*0.75 W/mK)=0.667° C./W, for a temperature rise of 66.7 degrees at 100 Watts. Using the present invention, a temperature rise of only 2.8 degrees would occur across the thermal interface between the device and the heat sink. This is according to the following: 50 E−6 m/1E−4 m²*17.8 W/mK=0.028° C./W.

The savings of over 60 degrees C. allows either much cooler operation of the device (greatly increasing expected lifetime) or use of a smaller (or thinner) heat sink for the same device operating temperature. Since heat sinks using only natural convection (no fan) become quite large for dissipation in the 100 Watt range, and also become expensive, the value of a superior thermal interface material demonstrates its advantages over conventional methods. The result in a typical application will be a reduction from a 0.94° C./W heat sink costing $9.21 in quantity and occupying a volume of 910 ml (Wakefield 423K, Digi-Key price), to a 1.16° C./W heat sink costing $6.08 in quantity and occupying only 494 ml (Wakefield 421K) when there is a switch from lower performance thermal interface material to a thermal interface according to the present invention. Yet after the switch, the same overall performance of the total thermal solution will be maintained.

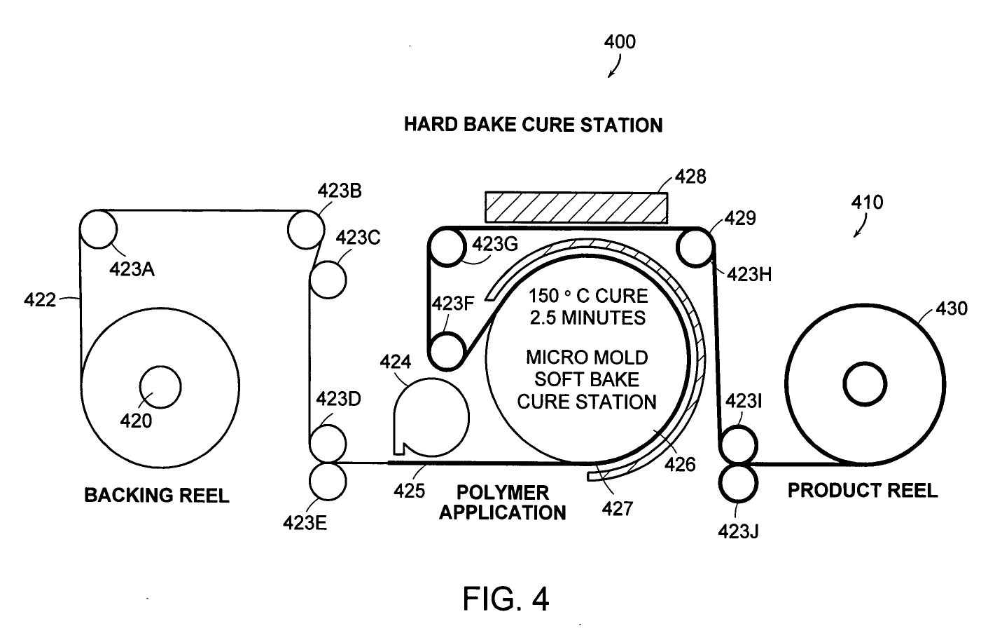

Another embodiment of the present invention for forming the thermal membrane includes roll-to-roll apparatus 410 shown in FIG. 4 generally at 400. This apparatus provides a method for forming the thermal membrane on a flexible backing layer that, preferably, may include using a soft lithographic method of micromolding. Referring to FIG. 4, roll-to-roll apparatus 410 and its method of operation will be described. Apparatus 410 uses a flexible elastomeric mold or stamp at the circumference of soft bake cure station 426 is to imprint or emboss a preset pattern of features onto or into a continuously moving sheet of liquid material dispensed on flexible backing 422 prior to encountering the roller of soft bake cure station 426 having the mold/stamp at the circumference. The features of the mold/stamp consist of embossed surface relief structures as well as through-holes that perforate the film. The mold/stamp comes into contact with the liquid material at 427. Any residual material that remains in the holes after the semi-cured thermal material leaves content with mold/stamp can be removed with an etching step. The stamps/molds can be made from a variety of elastromeric materials, such as PDMS, polyurethanes, and other silicone rubbers. The liquid materials include, but are not limited to, prepolymers, molten polymers, sol-gel precursors, composites of these materials with nanomaterial fillers.

The elastomeric stamp/mold has a surface treatment that prevents unwanted adhesion to the liquid material. While the elastomeric stamp/mold is in contact with the roller over approximately 270° of rotation, the liquid material undergoes a pre-curing reaction to semi-solidify the material. After the pre-cured, patterned film is separated from the roller, a secondary, final cure step can be performed at unit 428 to fully solidify the patterned film. The liquid material can be cured into a solid using a number of methods, such as UV irradiation, thermal baking, or chemical cross-linking. The thermal material at 429 is fully solidified.

Roll-to-roll apparatus 410 of the present invention also includes tooling and fixturing. For proper operator, for example, apparatus 410 includes backing supply roll 420 and take-up roll 430. The apparatus also includes guide rollers 423A-423J for channeling the flexible backing and film through the process.

Roll-to-roll apparatus 410 may be used to fabricate embossed products such as reflective tape, through-hole membranes that use roll-to-roll or web-based processing. Other possible uses include the fabrication of products used in thermal management in electronics. Another example of the use of molded articles according to the present invention is in the manufacture of thermally conducting adhesive pads used to channel heat from CPUs and power semiconductor devices to heat sinks.

The terms and expressions that are employed herein are terms of description and not of limitation. There is no intention in the use of such terms and expressions of excluding the equivalents of the feature shown or described, or portions thereof, it being recognized that various modifications are possible within the scope of the invention as claimed.

1. A composite thermal transfer membrane, comprising:
A flexible polymer membrane that is capable of having a thickness equal to or less than 100 *m having predetermined heat transfer and electrical insulating properties, with the polymer membrane having a plurality of through-openings disposed therein and the through-openings having predetermined shapes, and with the polymer membrane being capable of being disposed between a heat receiving device and a heat generating device that have non-planar surface areas and conforming to the non-planar surface shapes;
thermal transfer material having thermal condition and insulating properties, with the thermal transfer material being disposed in the through-openings of the polymer membrane and being flexible with the polymer membrane, the thermal transfer material having heat transfer properties such that the thermal transfer material will transfer heat per surface unit area at a rate greater than the polymer membrane.

2. The composite thermal transfer membrane as recited in claim 1, wherein the polymer membrane includes poly (dimethoxysilane) (PDMS) admixed with a conductive material.

3. The composite thermal transfer membrane as recited in claim 2, wherein the conductive material includes alumina.

4. The composite thermal transfer membrane as recited in claim 2, wherein the conductive material includes zinc oxide.

5. The composite thermal transfer membrane as recited in claim 2, wherein the conductive material includes alumina nitride.

6. The composite thermal transfer membrane as recited in claim 1, wherein the thermal transfer material fills a predetermined portion of the through-openings.

7. The composite thermal transfer membrane as recited in claim 6, wherein the thermal transfer material fills a portion of the through-openings to a predetermined thickness.

8. The composite thermal transfer membrane as recited in claim 7, wherein the thermal transfer material fills the through-openings in a range from a layer of thermal transfer material on the interior wall of the through-openings to completely filling the through-openings.

9. The composite thermal transfer membrane as recited in claim 8, wherein the plurality through-openings are capable of having at least two having different thicknesses of thermal transfer material.

10. The composite thermal transfer membrane as recited in claim 1, wherein the through-openings include being arrange in a predetermined pattern.
